(19) United States
(12) Patent Application Publication
(10) Pub. No.: US 2014/0278216 A1
(43) Pub. Date: Sep. 18, 2014

(54) DISPLACEMENT DETECTING DEVICE AND POWER SAVING METHOD THEREOF

(71) Applicant: PIXART IMAGING INC., Hsin-chu (TW)

(72) Inventors: CHUN-WEI CHEN, HSIN-CHU (TW); MENG-HUAN HSIEH, HSIN-CHU (TW)

(73) Assignee: PIXART IMAGING INC., Hsin-chu (TW)

(21) Appl. No.: 13/969,658

(22) Filed: Aug. 19, 2013

(30) Foreign Application Priority Data
Mar. 15, 2013 (TW) 102109312

(51) Int. Cl. G01B 21/16

(52) U.S. Cl. CPC G01B 21/16
USPC 702/150

(57) ABSTRACT

The present invention discloses a displacement detecting device including a displacement sensing module, an input module, a distance sensing module, and a processing module, and a power saving method thereof. The processing module is electrically connected to each module. The input module is used to supply non-contact operation. The distance sensing module is used to detect the distance between a body and the displacement detecting device, and then produces a sensing value. The processing module selectively control the displacement sensing module and the input module to be turned on or turned off according to the sensing result of the distance sensing module. The displacement detecting device turns on the displacement sensing module when the sensing value is less than a first default value, and turns on the input module and turns off the displacement sensing module when the sensing value is greater than a second default value.

### BACKGROUND

1. Technical Field

The present disclosure relates to a displacement detecting device; in particular, to a displacement detecting device capable of power saving and a power saving method thereof.

2. Description of Related Art

Optical mice gradually replace their mechanical predecessors in recent years for increasing the control accuracy when operating a host device such as a desktop or a laptop. Wireless optical mice are especially widely utilized, for their operational convenience.

However, components (such as the light source generator, the image sensor, the wireless transceiver and the controller) in a wireless optical mouse are powered by an internal battery. Hence if the components of the wireless optical mouse remain as on constantly, the power consumption of the internal battery of the wireless optical mouse increases sharply. Consequently the life cycle (or battery life) of the internal battery is reduced.

In order to reduce a frequency of battery replacement, a power saving switch is embedded to the bottom portion of a conventional wireless optical mouse. A user can manually switch on the power saving switch when the wireless optical mouse is not in use. Thus the components of the wireless optical mouse can be turned on or turned off selectively. However, the manual power saving switch is still considered inconvenient.

Therefore, certain wireless optical mice utilize a built-in light source generator and an image sensor to determine whether the wireless optical mouse has been idled for a predetermined period. In this regard, it can be controlled whether to disable certain components (such as the wireless transceiver and the controller) and keep the light source generator and the image sensor operating in the lowest possible operation current such that the normal operation mode can be resumed immediately when the user uses the wireless optical mouse again. However, since the light source generator and the image sensor still need to operate in the lowest possible operation current, significant power source will still be consumed over the time.

### SUMMARY

An exemplary embodiment of the present disclosure provides a displacement detecting device. The displacement detecting device comprises a displacement sensing module, a distance sensing module and a processing module. The input module provides non-contact operations to the displacement detecting device. The distance sensing module senses a distance between a target and the displacement detecting device, so as to generate a sensing value. The processing module is electrically connected to the displacement sensing module, the input module and the distance sensing module. The processing module selectively controls the displacement sensing module and the input module to be turned on or turned off according to the sensing value generated by the distance sensing module. When the sensing value is smaller than a first predetermined value, the displacement sensing module is turned on. When the sensing value is greater than a second predetermined value, the input module is turned on and the displacement sensing module is turned off.

Another exemplary embodiment of the present disclosure provides a power saving method of a displacement detecting device. The displacement detecting device has a displacement sensing module and an input module providing non-contact operations to the displacement detecting device. The power saving method comprises detecting a distance between a body and the displacement detecting device, for generating a sensing value. Then the displacement sensing module and the input module are selectively turned on or off according to the sensing value. When the sensing value is smaller than a first predetermined value, the displacement sensing module is turned on whereas when the sensing value is greater than a second predetermined value, the input module is turned on and the displacement sensing module is turned off.

In summary, embodiments of the present disclosure disclose a displacement detecting device and a power saving method thereof. By detecting a distance variation between a user's hand and the displacement detecting device via a distance sensing module in the displacement detecting device, the on or off state of the displacement sensing module and the input module can be controlled so as to reduce unnecessary power consumption and achieve power saving.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a block diagram illustrating a displacement detecting device according to an embodiment of the present disclosure;

FIG. 1B is a schematic diagram illustrating a displacement detecting device performing distance detection according to an embodiment of the present disclosure;

FIG. 2A is a schematic diagram illustrating an implementation of a proximity sensor on a displacement detecting device according to an embodiment of the present disclosure;

FIG. 2B is a schematic diagram illustrating an implementation of a proximity sensor on a displacement detecting device according to another embodiment of the present disclosure;

FIG. 3 is a flow chart illustrating a power saving method of a displacement detecting device according to an embodiment of the present disclosure; and

FIG. 4 is a flow chart illustrating a power saving method of a displacement detecting device according to another embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Please refer to FIG. 1A in conjunction with FIG. 1B. FIG. 1A is a block diagram illustrating a displacement detecting device according to an embodiment of the present disclosure. FIG. 1B is a schematic diagram illustrating a displacement detecting device performing distance detection according to an embodiment of the present disclosure. As shown in FIG. 1A and FIG. 1B, the displacement detecting device 1 comprises a displacement sensing module 10, a distance sensing module 11, an input module 12, a processing module 13, a storage module 14 and a transmission module 15. The displacement sensing module 10, the distance sensing module 11, the input module 12, the storage module 14 and the transmission module 15 are all electrically connected to the processing module 13. Practically, the displacement detecting device 1 can be an input apparatus of a host device (such as a desktop or a laptop) for locating a corresponding cursor on a display of the host device or inputting functional commands to the host device. In other words, the displacement detecting device 1 can be, for instance, an optical mouse or a laser mouse and can be operated on a working surface (such as a table). The description of each functional module of the displacement detecting device 1 is elaborated herein.

The displacement sensing module 10 is disposed on a side, which abuts against the working surface, of the displacement detecting device 1 for sensing a displacement magnitude and a displacement direction of the displacement detecting device 1 on the working surface. In general, the displacement sensing module 10 may further comprise a set of image sensing units and a set of light emitting units (not illustrated). The light emitting unit emits light (such as red light, blue light, invisible light or a laser beam) towards the working surface. The image sensing unit can then sense the displacement magnitude and the displacement direction of the displacement detecting device 1 on the working surface according to the light emitted by the light emitting unit.

For instance, if the light emitting unit emits the red light, the image sensing unit compares shade variations generated according to the surface roughness of the working surface. Then the image sensing unit calculates the displacement magnitude and the displacement direction of the displacement detecting device 1. If the displacement detecting device 1 is a laser mouse, the laser beam possesses directivity and can directly reflect the surface roughness of the working surface, therefore the image sensing unit calculating the displacement magnitude and the displacement direction of the displacement detecting device 1 directly.

Practically, the image sensing unit can be a charge coupled device (CCD) image sensor or a complementary metal oxide semiconductor (CMOS) image sensor, yet the present disclosure is not limited thereto.

The distance sensing module 11 senses a distance d between a target (such as a hand of the user) and the displacement detecting device 1. A set of sensing values is generated accordingly, as shown in FIG. 1B. The distance sensing module 11 is therefore disposed on the side of the displacement detecting device 1 to which the hand rests. Practically, the distance sensing module 11 comprises at least a proximity sensor. The proximity sensor determines whether a target is approaching or moving away according to a magnetic field variation. Those skilled in the art should appreciate the proximity sensor can be replaced by other distance sensors such as an infrared sensor, a laser sensor, an ultrasonic sensor or an optic sensor, as long as the distance d between the target and the distance sensor can be determined according to a magnitude of a reflected signal, and the present disclosure is not limited thereto. Furthermore, the abovementioned distance sensors are well known by those skilled in the art, and relevant descriptions are omitted hereafter.

The input module 12 provides the user to perform a non-contact operation to the displacement detecting device 1. For instance, the input module 12 can be a gesture sensing module, for detecting a hand gesture of the user. Practically, the input module 12 may be an image sensor or may comprise a plurality of proximity sensors. If the input module 12 is an image sensor, the input module 12 captures an image of the hand gesture periodically to determine the overall gesture in a certain period of time. If the input module 12 comprises a plurality of proximity sensors, the input module 12 determines a hand gesture of the user according to a variation of the magnetic field.

If the distance sensing module 11 and the input module 12 both comprise a plurality of proximity sensors, the displacement detecting device 1 can use the same kind of components (i.e., the proximity sensors) to achieve two different functional modules. Also, the internal circuitry design of the displacement detecting device 1 can be simplified. In this regard, not only the production cost can be reduced, but the production efficiency can also be effectively increased.

The processing module 13 can selectively control the displacement sensing module 10 and the input module 12 to be turned on or turned off according to a sensing result of the distance sensing module 11. More specifically, when the processing module 13 determines the sensing value transmitted from the distance sensing module 11 is smaller than a first predetermined value, the processing module 13 turns on the displacement sensing module 10. When the processing module 13 determines the sensing value transmitted from the distance sensing module 11 is greater than a second predetermined value, the processing module 13 turns on the input module 12 and turns off the displacement sensing module 10. When the processing module 13 determines the sensing value transmitted from the distance sensing module 11 is greater than a third predetermined value and the third predetermined value is greater than the second predetermined value, the processing module 13 turns off the displacement sensing module 10 and the input module 12.

The second predetermined value can be greater than or equal to the first predetermined value. For instance, if the second predetermined value is equal to the first predetermined value, the displacement detecting device 1 can only turn on or turn off two functional modules (i.e. the displacement sensing module 10 and the input module 12). If the second predetermined value is greater than the first predetermined value, at least one other functional module can be implemented when the sensing value is between the second predetermined value and the first predetermined value. This way, different function applications can be implemented according to a position of the hand of the user being at different distance from the displacement detecting device 1. Furthermore, the third predetermined value may be the maximum non-contact operation distance of the input module 12 of the displacement detecting device 1, and the present disclosure is not limited thereto.

The storage module 14 stores a relation between a gesture of the user and a corresponding functional operation. Practically the storage 14 can be non-volatile read-only memory (ROM) or non-volatile flash memory, but the present disclosure is not limited thereto.

The transmission module 15 transmits the information obtained from the displacement sensing module 10 and the input module 12 back to the host device such that the host device performs a corresponding operation. The present disclosure does not limit the transmission module 15 to perform transmission via a wired method or a wireless method.

Practically, if the second predetermined value is equal to the first predetermined value, when the distance d between the hand of the user and the displacement detecting device 1 is greater than the third predetermined value, it can be interpreted that the user does not intend to use the displacement detecting device 1 to operate the host device. In this case the displacement detecting device 1 turns off the displacement sensing module 10 and the input module 12 for saving power.

Subsequently, in the case when the hand of the user approaches the displacement detecting device 1 and a sensing value generated by the distance sensing module 11 falls between the first predetermined value and the third predetermined value (i.e., the sensing value is smaller than the third predetermined value but is greater than the first predetermined value). In other words, when the hand of the user is still away from the displacement detecting device 1 and cannot touch the displacement detecting device 1, the displacement detecting device 1 turns on the input module 12 and turns off the displacement sensing module 10 which is not required in this case, allowing a non-contact operation to command the host device.

In another case when the hand of the user is very close to the displacement detecting device 1 and a sensing value generated by the distance sensing module 11 is smaller than the first predetermined value. In other words, when the hand of the user actually touches the displacement detecting device 1, the displacement detecting device 1 turns off the input module 12 and turns on the displacement sensing module 10. This way, power consumption of the displacement detecting device 1 can be saved and the possible misjudgment of having both the input module 12 and the displacement sensing module 10 turned on at the same time can also be prevented.

Furthermore, if the distance sensing module 11 and the input module 12 both comprise a plurality of proximity sensors, the displacement detecting device 1 may have a plurality of functional operations according to a different number of proximity sensors used and different implementations of the proximity sensors.

Please refer to FIG. 2A and FIG. 2B. FIG. 2A is a diagram illustrating an implementation of a proximity sensor on the displacement detecting device according to an embodiment of the present disclosure. FIG. 2B is a diagram illustrating an implementation of the proximity sensor on the displacement detecting device according to another embodiment of the present disclosure. As shown in FIG. 2A and FIG. 2B, a distance sensing module 11 and an input module 12 are both disposed on a side of the displacement detecting devices 1a and 1b, allowing a hand for resting. The distance sensing module 11 and the input module 12 can be both realized by a plurality of proximity sensors.

The difference between FIG. 2A and FIG. 2B is that a plurality of proximity sensors of the input module 12 in FIG. 2A is arranged linearly in the displacement detecting device 1a whereas a plurality of proximity sensors of the input module 12 in FIG. 2B is arranged in a matrix in the displacement detecting device 1b. Different arrangements of the proximity sensors allow the displacement detecting devices 1a in FIG. 2A and the displacement detecting devices 1b in FIG. 2B to have different functional operations. For instance, because the plurality of proximity sensors of the displacement detecting device 1a in FIG. 2A is arranged linearly, the input module 12 is capable of identifying a single direction gesture (e.g. the hand moving towards the left or the right) of the hand such that the host device performs a functional operation such as page up or page down. Alternatively, the plurality of proximity sensors of the displacement detecting device 1b in FIG. 2B is arranged in a matrix, the input module 12 can identify a multi-direction gesture of the hand such that the host device can perform functional operations such as page up, page down, zoom-in, zoom-out or rotation, and the present disclosure is not limited thereto.

Other difference between FIG. 2A and FIG. 2B is that the distance sensing module 11 and the input module 12 in FIG. 2A are two separately independent modules whereas the distance sensing module 11 and the input module 12 in FIG. 2B can cooperate with each other. More specifically, the distance sensing module 11 in FIG. 2A simply detects a distance between a target and the displacement detecting device 1a and the input module 12 provides non-contact operations to control the displacement detecting device 1a. In contrast, when a sensing value generated by the distance sensing module 11 in FIG. 2B is greater than the third predetermined value, the distance sensing module 11 performs distance detection. In addition to distance detection, when a sensing value generated by the distance sensing module 11 in FIG. 2B is between the second predetermined value and the third predetermined value, the distance sensing module 11 can further provide non-contact operations to control the displacement detecting device 1b.

Please refer to FIG. 1A in conjunction with FIG. 3. FIG. 3 is a flow chart illustrating a power saving method of a displacement detecting device according to an embodiment of the present disclosure. As shown in FIG. 3, in step S30, the displacement detecting device 1 detects a distance between a body and the displacement detecting device 1 for generating a set of sensing values accordingly. In step S32, the displacement detecting device 1 determines a range in which the sensing values mentioned above are located. In step S34, the displacement detecting device 1 controls the displacement sensing module 10 and the input module 12 to be turned on or turned off according to a determining result of the step S32. When the abovementioned sensing value is smaller than the first predetermined value, the displacement detecting device 1 turns on the displacement sensing module 10. When the abovementioned sensing value is greater than the second predetermined value, the displacement detecting device 1 turns on the input module 12 and turns off the displacement sensing module 10.

In the present embodiment, the second predetermine value is greater than or equal to the first predetermined value. Additionally, the input module 12 can also be a gesture sensing module, for sensing a gesture of a hand, so the input module 12 can be an image sensor or comprise a plurality of proximity sensors for capturing an image of a hand gesture. Further, the function of sensing the distance between the body and the displacement detecting device 1 can also be achieved by the proximity sensor.

If the displacement detecting device 1 comprises a plurality of proximity sensors, the plurality of proximity sensors can be arranged linearly in the displacement detecting device 1 for identifying a single direction gesture of a hand. The plurality of proximity sensors may also be arranged in a matrix for identifying a multi-direction gesture of a hand.

Furthermore, in the present embodiment, when the sensing value mentioned above is greater than the third predetermined value and the third predetermined value is greater than the second predetermined value, the displacement detecting device 1 turns off the displacement sensing module 10 and the input module 12. In certain circumstances, when the sensing value mentioned above is smaller than the first predetermined value, the displacement detecting device 1 turns off the input module 12.

Please refer to FIG. 4. FIG. 4 is a flow chart illustrating the power saving method of the displacement detecting device according to another embodiment of the present disclosure. As shown in FIG. 4, in step S40, the displacement detecting device 1 detects a distance between a body and the displacement detecting device 1, for generating a set of sensing values accordingly. In step S41, the displacement detecting device 1 determines whether the sensing values are smaller than the first predetermined value. If the sensing values are smaller, then the displacement detecting device 1 turns on the displacement sensing module 10 (step S42). If the sensing values are larger than the first predetermined value, the displacement detecting device 1 determines whether the sensing values are greater than the second predetermined value (step S43).

In step S43, if the displacement detecting device 1 determines the sensing values are greater than the second predetermined value, step S44 carries on. In step S44, the displacement detecting device 1 determines whether the sensing values are smaller than the third predetermined value. If the sensing values are smaller than the third predetermined value, the displacement detecting device 1 turns on the input module 12 and turns off the displacement sensing module 10. If the sensing values are greater than the third predetermined value, the displacement detecting device 1 turns off the input module 12 and the displacement sensing module 10.

To the contrary, if the displacement detecting device 1 deduces the sensing values are smaller than the second predetermined value in step S43, step S47 carries on. In step S47, the displacement detecting device 1 determines whether the first predetermined value is equal to the second predetermined value. If the first predetermined value is not equal to the second predetermined value, other functional modules are performed (step S48). The other functional modules can be, for example, a voice-controlled module. If the first predetermined value is equal to the second predetermined value, step S41 is resumed.

Conventional method determines to enter a power saving mode according to an excessive idle time determined by the light generator and an image sensor. The displacement detecting device 1 of the present disclosure selectively turns on or turns off other functional modules according to a distance between a body and the displacement detecting device 1. For instance, by utilizing the displacement detecting device 1 of the present disclosure, the power consumption during power saving mode is further reduced from 0.035˜0.2 A (ampere) in a conventional optical mouse to 0.01 A so as to increase an average life cycle (or the battery life) of the battery in the displacement detecting device 1 from 13 months to 18 months. Hence the displacement detecting device 1 of the present disclosure is even more effective in power saving.

In summary, embodiments of the present disclosure disclose a displacement detecting device and a power saving method thereof. By detecting a distance variation between a user's hand and the displacement detecting device via a distance sensing module in the displacement detecting device, other functional modules can be controlled to be turned on off so as to reduce unnecessary power consumption for achieving power saving. Furthermore, since the distance sensing module and the gesture sensing module (for providing non-contact operations to the displacement detecting device) can be realized by a plurality of proximity sensors, the internal circuitry design of the displacement detecting device of the present disclosure can be further simplified.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A displacement detecting device, comprising:
a displacement sensing module;
an input module providing non-contact operations to the displacement detecting device;
a distance sensing module sensing a distance between a target and the displacement detecting device to generate a sensing value; and
a processing module electrically connected to the displacement sensing module, the input module and the distance sensing module, the processing module selectively controlling the displacement sensing module and the input module to be on or off according to the sensing value generated by the distance sensing module;
wherein, when the sensing value is smaller than a first predetermined value, the displacement sensing module is switched on, when the sensing value is greater than a second predetermined value, the input module is switched on and the displacement sensing module is switched off.

2. The displacement detecting device according to claim 1, wherein the second predetermined value is greater than or equal to the first predetermined value.

3. The displacement detecting device according to claim 1, wherein the input module is a gesture sensing module, for sensing a hand gesture.

4. The displacement detecting device according to claim 3, wherein the gesture sensing module is an image sensor, for capturing an image of the hand gesture.

5. The displacement detecting device according to claim 3, wherein the gesture sensing module comprises a plurality of proximity sensors.

6. The displacement detecting device according to claim 5, wherein the plurality of proximity sensors is arranged in a matrix in the displacement detecting device, for the gesture sensing module identifying a multi-direction hand gesture.

7. The displacement detecting device according to claim 5, wherein the plurality of proximity sensors is arranged linearly in the displacement detecting device.

8. The displacement detecting device according to claim 1, wherein the distance sensing module comprises at least a proximity sensor.

9. The displacement detecting device according to claim 1, wherein when the sensing value is greater than a third predetermined value and the third predetermined value is greater than the second predetermined value, the processing module switches off the displacement sensing module and the input module.

10. The displacement detecting device according to claim 1, wherein when the sensing value is smaller than the first predetermined value, the input module is switched off.

11. The displacement detecting device according to claim 1, wherein the displacement detecting module further comprising:
a storage module electrically connected to the processing module and storing a relationship information between a gesture of the target and a corresponding functional operation; and
a transmission module electrically connected to the processing module for transmitting information obtained from the displacement sensing module and the input module back to a host device that performs a corresponding operation.

12. A power saving method of a displacement detecting device, the displacement detecting device having a displacement sensing module and an input module providing non-contact operations to the displacement detecting device, the power saving method comprising:
detecting a distance between a target and the displacement detecting device, for generating a sensing value; and
selectively turning on or off the displacement sensing module and the input module according to the sensing value, wherein when the sensing value is smaller than a first predetermined value, the displacement sensing module is turned on and when the sensing value is greater than a second predetermined value, the input module is turned on and the displacement sensing module is turned off.

13. The power saving method of the displacement detecting device according to claim 12, wherein the second predetermined value is greater than or equal to the first predetermined value.

14. The power saving method of the displacement detecting device according to claim 12, wherein the input module is a gesture sensing module for sensing a hand gesture.

15. The power saving method of the displacement detecting device according to claim 14, wherein the gesture sensing module comprises a plurality of proximity sensors.

16. The power saving method of the displacement detecting device according to claim 15, wherein the plurality of proximity sensors is arranged in a matrix in the displacement detecting device for the gesture sensing module identifying a multi-direction hand gesture.

17. The power saving method of the displacement detecting device according to claim 15, wherein the plurality of proximity sensors is arranged linearly in the displacement detecting device.

18. The power saving method of the displacement detecting device according to claim 12, wherein detecting the distance between the target and the displacement detecting device is performed by a proximity sensor.

19. The power saving method of the displacement detecting device according to claim 12, wherein when the sensing value is greater than a third predetermined value and the third predetermined value is greater than the second predetermined value, the displacement sensing module and the input module are turned off.

20. The power saving method of the displacement detecting device according to claim 12, wherein when the sensing value is smaller than the first predetermined value, the input module is turned off.
